(19) United States
(12) Patent Application Publication
(10) Pub. No.: US 2018/0083342 A1
(43) Pub. Date: Mar. 22, 2018

(54) WIRELESS COMMUNICATION DEVICE HAVING A SLOT ANTENNA

(71) Applicant: TYCO ELECTRONICS CORPORATION, Berwyn, PA (US)

(72) Inventors: Hilario Lepe, Gilroy, CA (US); Bruce Foster Bishop, Aptos, CA (US)

(21) Appl. No.: 15/269,188

(22) Filed: Sep. 19, 2016

(51) Int. Cl. H01Q 1/24; H01Q 13/10; H01Q 1/27; H01Q 1/48

(52) U.S. Cl. CPC H01Q 1/243; H01Q 1/48; H01Q 1/273; H01Q 13/106

(57) ABSTRACT

Wireless communication device includes a casing having a body wall that includes an inner surface that surrounds an interior cavity of the casing. The casing has an edge that defines an opening to the interior cavity. The wireless communication device also includes an antenna element positioned at the opening or within the interior cavity. The antenna element has an outer edge that is shaped to extend generally along and spaced apart from the inner surface such that the outer edge and the inner surface form an operative slot therebetween. The wireless communication device also includes a feed line communicatively coupled to the operative slot. The feed line and the operative slot form a slot antenna that is configured to at least one of transmit or receive radio-frequency (RF) waves.

### BACKGROUND

The subject matter relates generally to wireless communication devices and to slot antennas that may be used by wireless communication devices.

Wireless communication devices are increasingly used by consumers and have an expanding number of applications within a variety of industries. Some devices, such as smartphones, smartwatches, fitness trackers, and/or music players, are configured to be held or worn by an individual for an extended period of time. These devices often include one or more integrated antennas that allow for wireless communication within a communication network. Recently, there have been two conflicting market demands for wireless devices. Users generally demand wireless devices that are smaller or weigh less, but the users also desire better performances and/or a greater number of capabilities. Features that have improved recently include data storage, battery life, and cameras, among other things.

To provide smaller devices with improved performances and more capabilities, manufacturers have attempted to optimize the available space within the wireless device by resizing components of the wireless device or by moving the components. For example, the size and shape of an antenna may be reconfigured and/or the antenna may be moved to a different location within the wireless device. The number of available locations for an antenna, however, is limited not only by other components of the wireless device, but also by government regulations and/or industry requirements, such as those relating to specific absorption rate (SAR). In some known wearable devices, antennas (e.g., planar inverted-F antenna (PIFA)) are positioned within an interior cavity of the body of the wearable device. In other proposed wearable devices, a slot has been formed through the body or casing of the wearable device. Although these antennas can be effective in communicating wirelessly, alternative antennas which provide sufficient communication while occupying less space allowing other device designs are desired.

### BRIEF DESCRIPTION

In an embodiment, a wireless communication device is provided. The wireless communication device includes a casing having a body wall that includes an inner surface that surrounds an interior cavity of the casing. The casing has an edge that defines an opening to the interior cavity. Optionally, a device cover or, alternatively, a user interface may be positioned to cover the opening. The wireless communication device also includes an antenna element positioned at the opening or within the interior cavity. The antenna element has an outer edge that is shaped to extend generally along and spaced apart from the inner surface such that the outer edge and the inner surface form an operative slot therebetween. The wireless communication device also includes a feed line communicatively coupled to the operative slot. The feed line and the operative slot form a slot antenna that is configured to at least one of transmit or receive radio-frequency (RF) waves.

In an embodiment, a wireless communication device is provided. The wireless communication device includes a user interface having an electronic display that is configured to generate light. The user interface also includes a transparent substrate coupled to the electronic display. The transparent substrate has a display side of the wireless communication device and is configured to permit the light to propagate through the transparent substrate. The wireless communication device also includes a casing having a body wall that includes an inner surface that surrounds an interior cavity of the casing. The casing has an edge that defines an opening to the interior cavity. The user interface is positioned to cover the opening. The wireless communication device also includes an antenna element positioned at the opening or within the interior cavity. The antenna element has an outer edge that is shaped to extend generally along and spaced apart from the inner surface such that the outer edge and the inner surface form an operative slot therebetween. The wireless communication device also includes a feed line communicatively coupled to the operative slot. The feed line and the operative slot form a slot antenna that is configured to at least one of transmit or receive radio-frequency (RF) waves.

In one aspect, the wireless communication device may also include at least one strap that is coupled to the casing and configured to wrap about a limb of an individual. The wireless communication device may be a wearable electronic device.

In some aspects, the operative slot may coincide with an antenna plane that is parallel to the display side of the wireless communication device.

In some aspects, the antenna element may have a side surface that faces the user interface. The side surface of the antenna element may be secured to a cavity side of the user interface such that the user interface holds the antenna element in an essentially fixed position during operation of the wireless communication device.

In some aspects, the electronic display, the transparent substrate, and the antenna element have respective two-dimensional structures that are stacked with respect to one another.

In some aspects, the antenna element may include a main section and a ground extension that projects from the main section and engages the inner surface. The ground extension may define an end of the operative slot. Optionally, the ground extension may be a first ground extension and the antenna element may include a second ground extension that projects from the main section and engages the inner surface. The operative slot may be defined between the first and second ground extensions. Also optionally, the ground extension may include a ground finger. The ground finger may be deflected away from the user interface when engaged to the inner surface.

In some aspects, the inner surface may extend entirely about a central axis that is perpendicular to the display side and define a perimeter of the interior cavity. The operative slot may extend along at least one-third of the perimeter.

In some aspects, the antenna element has an inner edge that defines a void. The wireless communication device may include at least one other object disposed in the void.

In some aspects, the opening of the casing is a first opening. The casing may include a base edge that defines a second opening. The wireless communication device may also include a base wall that covers the second opening and is coupled to the casing.

In some aspects, the wireless communication device also includes a processor that is disposed in the interior cavity and operably coupled to the electronic display. The processor may be configured to control operation of the electronic display to display graphical objects to a user of the wireless communication device. The processor may be secured to the base wall.

In an embodiment, a wearable electronic device is provided. The wearable electronic device includes a casing having a body wall that includes an inner surface surrounding an interior cavity of the casing. The wearable electronic device also includes at least one strap that is coupled to the casing and configured to wrap about a limb of an individual. The wearable electronic device also includes an antenna element that is positioned within the interior cavity of the casing. The antenna element has an outer edge that is shaped to extend generally along and spaced apart from the inner surface such that the outer edge and the inner surface form an operative slot therebetween. The wearable electronic device also includes a feed line that is communicatively coupled to the operative slot. The feed line and the operative slot form a slot antenna that is configured to at least one of transmit or receive radio-frequency (RF) waves.

In one aspect, the casing includes a base wall that is configured to be positioned adjacent to the individual. The operative slot may coincide with an antenna plane that is parallel to the base wall.

In some aspects, the antenna element may include a main section and a ground extension that projects from the main section and engages the inner surface. The ground extension may define an end of the operative slot. Optionally, the ground extension may be a first ground extension and the antenna element may include a second ground extension that projects from the main section and engages the inner surface. The operative slot may be defined between the first and second ground extensions. Also optionally, the ground extension may include a ground finger. The ground finger may be deflected toward a bottom of the wearable electronic device that is configured to be adjacent to the individual.

In some aspects, the inner surface may extend entirely about a central axis and define a perimeter of the interior cavity. The operative slot may extend along at least one-third of the perimeter.

In some aspects, the antenna element may have an inner edge that defines a void. The wearable electronic device may include at least one other object disposed in the void.

In some aspects, the wearable electronic device may also include a device cover coupled to the casing. The antenna element may have a side surface that faces the device cover. The side surface of the antenna element may be secured to a cavity side of the device cover such that the device cover holds the antenna element in an essentially fixed position during operation of the wearable electronic device.

### BRIEF DESCRIPTION OF THE DRAWINGS

FIG. 1 is a top plan view of a wireless communication device formed in accordance with a specific embodiment.

FIG. 2 is an exploded view of the wireless communication device of FIG. 1.

FIG. 3 is a bottom perspective view of a sub-assembly that may be used with the wireless communication device of FIG. 1, according to a specific embodiment.

FIG. 4 is an isolated plan view of an antenna element that may be used with the wireless communication device of FIG. 1, according to a specific embodiment.

FIG. 5 is a side cross-section of the wireless communication device of FIG. 1.

FIG. 6 is a top-down cross-sectional view of the wireless communication device of FIG. 1, according to a specific embodiment.

FIG. 7 illustrates a plan view of a casing that may be used with the wireless communication device of FIG. 1 and the antenna element of FIG. 4 according to a specific embodiment.

FIG. 8 is an enlarged view of a portion of the wireless communication device of FIG. 1, according to a specific embodiment, with the casing of FIG. 7 removed.

FIG. 9 is an enlarged view of a cross-section of the wireless communication device of FIG. 1 illustrating a portion of a slot antenna, according to a specific embodiment.

FIG. 10 is a perspective view of a portion of a wireless communication device according to another specific embodiment.

FIG. 11 is a side cross-sectional view of a wireless communication device according to another specific embodiment.

### DETAILED DESCRIPTION

Embodiments set forth herein include wireless communication devices having one or more slot antennas. A wireless communication device is hereinafter referred to as a wireless device. The wireless devices set forth herein are typically portable. In particular embodiments, the wireless devices are sized and shaped to be wearable and/or capable of being held in a single hand by an average-sized adult. Examples of wearable or handheld wireless devices include smartphones, media players, smartwatches, activity trackers, and/or game players.

A wireless device typically includes a casing (e.g., a housing or body) that surrounds an interior cavity of the wireless device where operable components of the wireless device are held. The casing may include one or more discrete elements and comprise one or more types of material. Embodiments set forth herein include slot antennas that are formed by an antenna element within the interior cavity and a conductive inner surface of the casing that is exposed to the interior cavity. More specifically, the antenna element and the conductive inner surface may be positioned relative to one another such that an operative slot exists therebetween. The operative slot is communicatively coupled to a feed line that excites the operative slot, thereby forming a slot antenna. The feed line allows a component of the wireless device (e.g., radio) to transmit and/or receive radio-frequency (RF) waves through the slot antenna.

For purposes of the present disclosure, the term “RF” is used broadly to include a wide range of electromagnetic transmission frequencies including, for instance, those falling within the radio frequency, microwave, or millimeter wave frequency ranges. Embodiments may communicate at one or more designated RF frequencies or bands. In particular embodiments, the slot antenna is configured to communicate at a single center frequency. For example, the slot antenna may be configured to communicate at a center frequency of 2.4 gigahertz (GHz). In other embodiments, however, the slot antenna may communicate within multiple frequency bands having different center frequencies.

Optionally, embodiments may include multiple slot antennas in which each slot antenna has a frequency band that is centered at a different frequency. For instance, a first slot antenna may have a first frequency band that is centered at 2.4 GHz, and a second slot antenna may have a second frequency band that is centered at 1.8 GHz. It should be understood, however, that wireless devices and slot antennas described herein are not limited to particular frequency bands and other frequency bands may be used. Likewise, it should be understood that wireless devices and slot antennas described herein are not limited to particular wireless technologies (e.g., Global Positioning System (GPS), Bluetooth, Wi-Fi, and WiMax) and other wireless technologies may be used.

In some embodiments, the wireless device may use different types of antennas for communicating wirelessly. For example, a wireless device may have one or more of the slot antennas, as described herein or other variations of slot antennas, and also include an antenna configured for short range technology (e.g., near field communication (NFC)). In particular embodiments, the slot antenna and the NFC antenna use respective two-dimensional structures that are substantially coplanar.

In particular embodiments, the antenna element is secured to another operable component of the wireless device and held in a fixed position within the interior cavity by the operable component. For example, embodiments may include a wearable electronic device having a user interface. Various components or portions thereof may be essentially two-dimensional structures. As used herein, an object or component has an “essentially two-dimensional structure” if nearly an entirety of the object or component (or portion thereof) extends parallel to a plane along a length and a width and has a height or thickness that is significantly smaller than the length or the width. The user interface may be an essentially two-dimensional structure (e.g., liquid crystal display (LCD), organic light emitting diode (OLED) display, keypad, touchpad, and the like) that is coupled to the casing. The antenna element may also be an essentially two-dimensional structure that is secured to a side of the user interface. During operation, the antenna element may be held at a fixed position within the interior cavity by the user interface.

Alternative embodiments may include wireless devices that do not have a user interface, such as an activity tracker or a conventional timepiece. In such embodiments, the antenna element may be secured to a side of a cover of the wireless device. The cover may form a part of the casing or may form a backing to a conventional time display. For instance, a cover may replace the user interface as described below with respect to the illustrated embodiment.

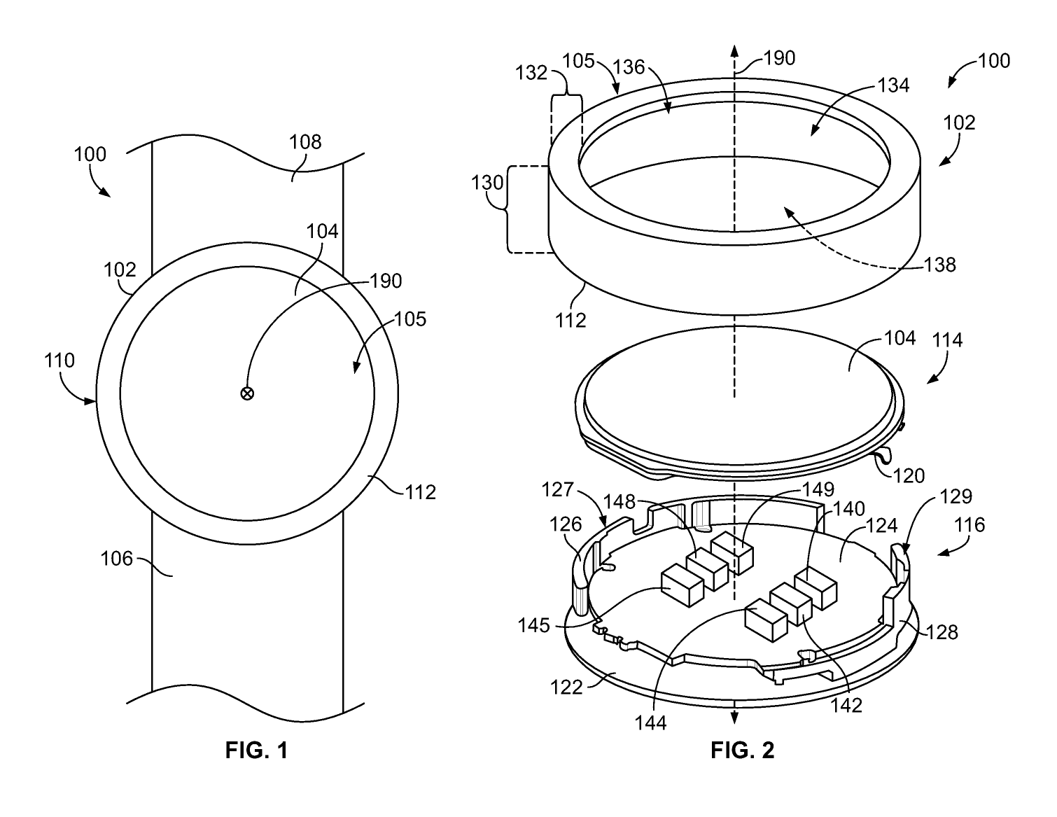

FIG. 1 illustrates a plan view of a wireless device 100 formed in accordance with an embodiment. The wireless device may be a wearable electronic device. In the illustrated embodiment, the wireless device 100 is an electronic watch or timepiece that is configured to be worn around the wrist of an individual. The electronic watch may be referred to as a smartwatch that is capable of displaying different images or graphical objects and is capable of receiving and responding to user inputs. In other embodiments, the wireless device may be a portable phone (e.g., smartphone). Yet in other embodiments, the wireless device 100 may be an activity tracker.

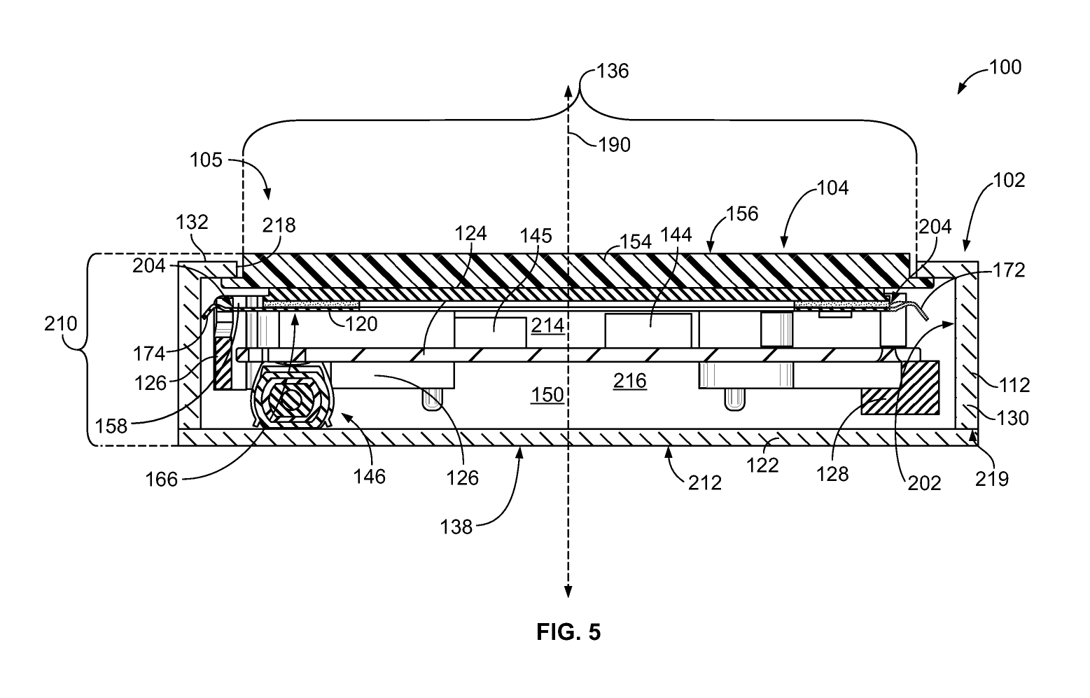

The wireless device 100 includes a casing 102 and a user interface 104 that is configured to be coupled to the casing 102. The casing 102 is a housing or body of the wireless device 100 that holds and protects internal working components. More specifically, the casing 102 has an interior cavity 150 (shown in FIG. 5) where various components for operating the wireless device 100 are disposed. The casing 102 defines an exterior surface 110 that is exposed to the surrounding environment. The user interface 104 and, optionally, a portion of the casing 102 may combine to form a top side 105 of the wireless device 100. The top side 105 may face away from the individual's body during operation. The wireless device 100 also includes first and second straps 106, 108 that are configured to wrap about a limb (e.g., arm) of the individual. In other embodiments, the wireless device 100 may include only a single strap or may not include any straps.

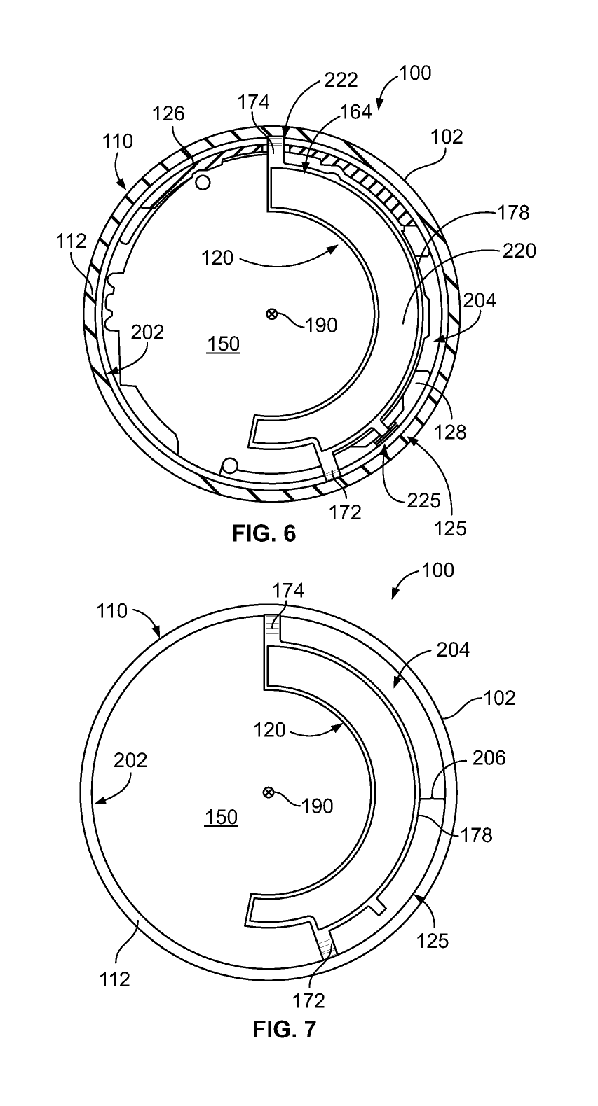

As described herein, a portion of the casing 102 may be used to form a slot antenna. The casing 102 is a structural element of the wireless device 100 that enhances the structural integrity of the wireless device 100 and/or protects at least one component of the wireless device 100, wherein the protected component is other than the slot antenna. For example, the casing 102 includes a body wall 112 that extends continuously around a central axis 190. In the illustrated embodiment, the body wall 112 includes at least a portion of the exterior surface 110. The body wall 112 surrounds the interior cavity 150 (FIG. 5). As described herein, the body wall 112 may be conductive and may have an inner surface 202 (shown in FIG. 5) that partially defines a slot antenna 125 (shown in FIG. 6). Other examples of structural elements that may be used to form a slot antenna include an interior wall that extends through the interior cavity. The body wall 112 not only defines and protects the slot antenna 125, but also protects other operable components as described herein.

Structural elements, such as the casing 102 and/or the body wall 112, may be molded, stamped-and-formed, die cast, and/or the like. Structural elements may have a uniform composition throughout the structural element. For example, the portion of the body wall 112 which forms part of the slot antenna 125 may have the same composition as a different portion that, for example, protects another operable component and/or enhances the structural integrity of the wireless device. In other embodiments, however, the casing 102 or the body wall 112 may have different compositions and/or be constructed from discrete elements.

The user interface 104 is configured to generate light to create images or graphical objects that are viewable to an individual. For example, the user interface 104 may present an image of a clock that shows the current time. In an exemplary embodiment, the user interface 104 is a touchscreen that is capable of detecting a touch from the individual and identifying a location of the touch within the display area. The touch may be from a user's finger and/or a stylus or other object. The user interface 104 may implement one or more touchscreen technologies. In other embodiments, however, the user interface 104 is not a touchscreen that is capable of identifying touches.

FIG. 2 is an exploded view of the wireless device 100. As shown, the wireless device 100 includes the casing 102, a first sub-assembly 114, and a second sub-assembly 116. In some embodiments, the first sub-assembly 114 may be referred to as the display assembly, and the second sub-assembly 116 may be referred to as the interior assembly. In the illustrated embodiment, the first sub-assembly 114 includes the user interface 104 and an antenna element 120 that is directly coupled to the user interface 104. In other embodiments, however, the antenna element 120 is not directly coupled to the user interface 104. In the illustrated embodiment, the second sub-assembly 116 includes a base wall 122, a printed circuit 124, and interior supports 126, 128. In other embodiments, however, the second sub-assembly 116 does not include the base wall 122. Each of the first and second sub-assemblies 114, 116 may include additional components of the wireless device 100 as described herein.

The casing 102, the first sub-assembly 114, and the second sub-assembly 116 are configured to be stacked with respect to one another during assembly along the central axis 190 (or stacking axis). The casing 102 may comprise a common material throughout. For example, the casing 102 may be molded or die cast to include the features described herein.

In other embodiments, the casing 102 may be an integrated structure formed from multiple types of material and/or discrete elements that are secured to one another. For example, the casing 102 may comprise a ring that is partially overmolded such that a conductive inner surface of the ring is exposed to the interior cavity. The ring may or may not be exposed to the exterior. In such embodiments, the ring may define a portion of the slot antenna. Yet in other embodiments, only a section of the casing comprises a conductive material. The section may be overmolded such that a conductive inner surface of the section is exposed to the interior cavity. In such embodiments, the section of the casing may define a portion of the slot antenna.

As shown, the body wall 112 of the casing 102 includes a vertical section 130 and a ledge section 132. The vertical section 130 extends along the central axis 190 to define a height of the casing 102. The ledge section 132 extends radially-inward from the vertical section 130 and toward the central axis 190. In the illustrated embodiment, the vertical section 130 and the ledge section 132 have uniform thicknesses and shapes. In other embodiments, however, the vertical and ledge sections 130, 132 may have varying thicknesses or shapes. For example, in some embodiments, the vertical section 130 may include radial projections that are configured to engage at least one of the first and second straps 106, 108. The exterior surface 110 may also be shaped to include ornamental features.

As shown in FIG. 2, the casing 102 has a first opening 136 along a top of the casing 102 and an opposite second opening 138 along a bottom of the casing 102. A passage 134 extends between the first and second openings 136, 138. The passage 134 is configured to receive various components and become the interior cavity 150 (FIG. 5) of the wireless device 100. For example, the first sub-assembly 114 may be inserted through the second opening 138 and positioned within the passage 134 such that a portion of the user interface 104 is exposed along the top side 105 of the wireless device 100. The portion of the user interface 104 may be inserted through the first opening 136 during manufacturing.

The second sub-assembly 116 may follow the first sub-assembly 114 during manufacturing and be inserted through the second opening 138. The interior supports 126, 128 have support surfaces 127, 129, respectively, that are configured to engage or interface with the user interface 104 within the interior cavity 150. The interior supports 126, 128 and the casing 102 may be shaped relative to one another to hold the user interface 104 therebetween. The user interface 104 may be held in an essentially fixed position. After the second sub-assembly 116 is disposed within the interior cavity 150, the base wall 122 may be secured to the casing 102. For example, hardware and/or adhesives (not shown) may be used to secure the casing 102 and the base wall 122 to each other.

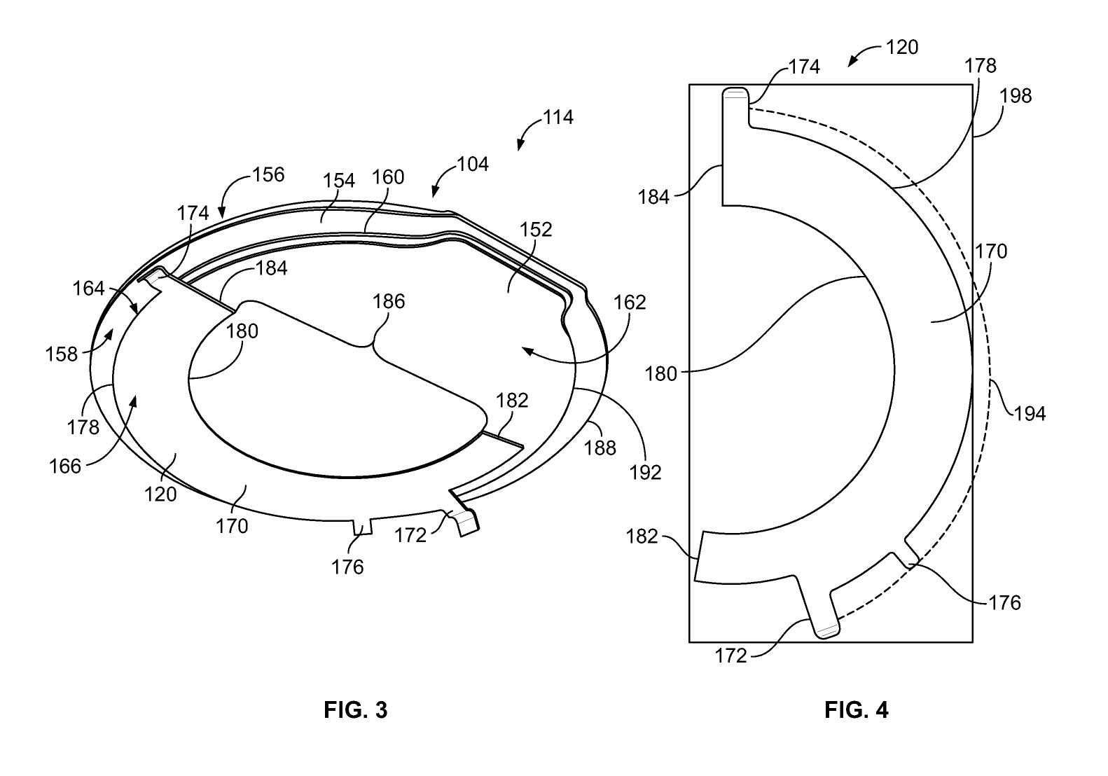

The second sub-assembly 116 may include one or more operable components of the wireless device. The second sub-assembly 116 may be a modular unit such that the operable components are secured to at least one of the base wall 122, the printed circuit 124, or the interior supports 126, 128. As such, the second sub-assembly 116 may be inserted into the interior cavity 150 as a single unit. By way of example, the operable components may include a radio 140, a processor 142, a power source (e.g., battery) 144, a wireless power transfer coil (not shown), memory 145, an accelerometer or gyroscope (not shown), optional antennas (e.g., near-field antenna) (not shown), and a vibrator 146 (shown in FIG. 3). The processor 142 may be operably coupled to the electronic display 152. The processor 142 may be configured to control operation of the electronic display 152 to display graphical objects to a user of the wireless communication device 100.

The operable components may also include a plurality of controllers, such as a haptic controller 148 that is configured to control the vibrator 146 and a touchscreen controller 149 that is communicatively coupled to the user interface 104. As shown, the operable components 140, 142, 144, 145, 148, and 149 are coupled to a top surface of the printed circuit 124. In other embodiments, the surface side of the printed circuit 124 may have one or more operable components coupled thereto. It should be understood that the operable components are represented as generic blocks in FIG. 2. The operable components may have various shapes and sizes. Moreover, the operable components may be combined into a single device or unit. For example, the same controller may form the haptic controller and the touchscreen controller.

FIG. 3 is a bottom perspective view of the first sub-assembly 114. In some embodiments, the first sub-assembly 114 is a modular unit such that the different components of the first sub-assembly 114 are held in fixed positions relative to one another and the first sub-assembly 114 may be moved as a single unit (e.g., during manufacture). For example, in some embodiments, the first sub-assembly 114 includes the user interface 104 and the antenna element 120 secured to one another.

In the illustrated embodiment, the user interface 104 includes an electronic display 152 and a transparent substrate 154 (e.g., glass) that are stacked side-by-side. In particular embodiments, the electronic display 152, the transparent substrate 154, and the antenna element 120 have respective two-dimensional structures that are stacked with respect to one another. The electronic display 152 may be, for example, a liquid crystal display (LCD) or an organic light emitting diode (OLED) display, but other electronic displays are contemplated. The electronic display 152 is configured to generate light that is directed toward an exterior of the wireless device 100. The transparent substrate 154 is configured to permit the light to propagate therethrough. The transparent substrate 154 has a display side 156 and an opposite cavity side 158. The display side 156 and the cavity side 158 face in opposite directions along the central axis 190 (FIG. 2). The display side 156 is configured to face the exterior, and the cavity side 158 is configured to face the interior cavity 150. The cavity side 158 may engage or interface with the interior supports 126, 128 (FIG. 2). The electronic display 152 includes a substrate side 160 and an opposite cavity side 162. The substrate side 160 may be secured to the cavity side 158 of the transparent substrate 154. The cavity side 162 of the electronic display 152 may be secured to the antenna element 120.

The antenna element 120 comprises a conductive material and is configured to form part of the slot antenna 125 (FIG. 6). In the illustrated embodiment, the antenna element 120 includes a first side surface 164 and an opposite second side surface 166. The first side surface 164 of the antenna element 120 is secured to the cavity side 162 of the electronic display 152. For example, an adhesive 220 (shown in FIG. 6) may be used to secure the electronic display 152 and the antenna element 120 to each other.

In some embodiments, the antenna element 120 is stamped and formed from sheet metal. In other embodiments, however, the antenna element 120 may be manufactured using other methods. For example, an antenna element may be part of a flexible printed circuit (FPC). An FPC includes one or more conductive layers stacked with respect to flexible dielectric layers. At least one of the conductive layers may function as the antenna element. In such embodiments, the conductive layer may be exposed through a dielectric layer or layers for engaging other conductive elements of the wireless device. For example, a section of the FPC that includes an exposed portion of the conductive layer may be sandwiched between the transparent substrate of the user interface and the casing such that the conductive layer is electrically coupled to the casing. As another example, the exposed portion of the conductive layer may directly engage a ground finger of another component of the wireless device. Optionally, the FPC may also be secured to the transparent substrate or other component of the wireless device through an adhesive.

In other embodiments, the antenna element 120 may be manufactured through laser direct structuring (LDS), two-shot molding (dielectric with copper traces), and/or ink-printing. In such embodiments, dielectric structures may be manufactured by molding a dielectric body (e.g., thermoplastic) into a designated shape. The antenna element may then be disposed on surfaces of the mold through, for example, ink-printing. Alternatively, the antenna element may be first formed and then a dielectric body may be molded around at least a portion of the antenna element. For example, the antenna element may be stamped from sheet metal, disposed within a cavity, and then surrounded by a thermoplastic material that is injected into the cavity. The dielectric body may include only a single dielectric element or may include a combination of dielectric elements. For such embodiments in which the antenna element is formed with a dielectric material, the antenna element and the dielectric material may form a part of the first sub-assembly 114 or may be inserted as a unit into the interior cavity 150. Yet in another embodiment, the antenna element may be ink-printed directly onto the transparent substrate or other component of the wireless device.

In the illustrated embodiment, the antenna element 120 has a main section 170, first and second ground extensions 172, 174 which project from the main section 170, and a coupling extension 176 which projects from the main section 170. The first and second ground extensions 172, 174 are configured to engage the inner surface 202 (FIG. 5) of the casing 102. The coupling extension 176 is configured to capacitively couple to a feed line 225 (shown in FIG. 8). In the illustrated embodiment, the first and second ground extensions 172, 174 are ground fingers that are configured to be deflected when engaged to the inner surface 202. The first and second ground extensions 172, 174 may be deflected away from the user interface 104 and/or toward a bottom of the wireless device 100.

The main section 170 has an outer edge 178 and an inner edge 180 of the antenna element 120. The outer edge 178 is shaped to extend generally along and spaced apart from an inner surface 202 of the body wall 1112 such that the outer edge 178 and the inner surface 202 form an operative slot 204 (shown in FIG. 6). In the illustrated embodiment, the outer edge 178 has a curved contour that curves at an essentially uniform radius of curvature between the first and second ground extensions 172, 174. In other embodiments, however, the outer edge 178 may have segments that curve at different radiuses of curvature. It is also contemplated that one or more segments of the outer edge 178 may extend in a linear manner for a portion of the operative slot 204. Accordingly, the outer edge 178 may take a variety of paths.

In the illustrated embodiment, the inner edge 180 has a curved contour that curves at an essentially uniform radius of curvature between opposite ends 182, 184 of the antenna element 120. Similar to the outer edge 178, however, the inner edge 180 may also extend along a variety of paths. The inner edge 180 may define a void 186 that exposes the cavity side 162 of the electronic display 152 to the interior cavity 150. In some embodiments, the void 186 may provide additional space for an object of the wireless communication device 100 to occupy and/or to further separate the electronic display 152 from other objects. The object may be, for example, one of the operable components 140, 142, 144, 145, 148, and 149 (FIG. 2) or an NFC antenna element.

The transparent substrate 154 has a substrate edge 188 that defines a perimeter of the transparent substrate 154, and the electronic display 152 has a display edge 192 that defines a perimeter of the electronic display 152. In some embodiment, the transparent substrate 154 is sized and shaped such that the transparent substrate 154 radially or laterally clears the display edge 192 of the electronic display 152. In the illustrated embodiment, the first and second ground extensions 172, 174 radially or laterally clear the substrate edge 188. As used herein, the term “radially clears” or “laterally clears” means that a first object extends beyond the edge of a second object along a plane that is perpendicular to the central axis 190 (FIG. 1).

FIG. 4 is a plan view of the antenna element 120. In the illustrated embodiment, the outer edge 178 coincides with an antenna plane 198. The main section 170 may also coincide with the antenna plane 198. The antenna plane 198 extends along the page in FIG. 4. It should be understood, however, that the outer edge 178 may diverge from the antenna plane 198 in other embodiments. In the illustrated embodiment, the antenna element 120 is an essentially two-dimensional structure that coincides with the antenna plane 198 in which only the first and second ground extensions 172, 174 bend into or out of the antenna plane 198. As used herein, an antenna element has an “essentially two-dimensional structure” if the main section 170 of the antenna element 120 coincides with the antenna plane 198. However, it should be understood that the antenna element 120 may not be an essentially two-dimensional structure in other embodiments. For example, one or more portions of the main section 170 may bend in or out of the antenna plane 198.

The first and second ground extensions 172, 174 are separated from each other by a slot length 194 (FIG. 4) of the operative slot 204 (shown in FIG. 5). The slot length 194 may be measured along a center line (represented by a dashed line in FIG. 4) between the outer edge 178 and the inner surface 202 of the body wall 112. The center frequency of the slot antenna 125 may be a function of the slot length 194, among other parameters. The location of the coupling extension 176 may also be configured to control performance of the slot antenna 125 (FIG. 6). However, the coupling extension 176 is optional and may be removed in other embodiments. It is also contemplated that the antenna element 120 may have a single ground extension such that the operative slot was defined at both ends by the same ground extension.

The antenna element 120 extends between the antenna ends 182, 184 and has an antenna length therebetween. The antenna element 120 is semi-circular or substantially C-shaped in the illustrated embodiment. In other embodiments, however, the antenna element 120 may have a length that is greater than or less than the antenna length shown in FIG. 4. Yet in other embodiments, the antenna element 120 does not have an inner edge 180. In such embodiments, the antenna element 120 may be substantially disc-shaped and the outer edge 178 may extend along an entirety of the inner surface or only a portion of the inner surface.

FIG. 5 is a cross-section of the wireless device 100 after being fully constructed and illustrates the relative positions of the components in the interior cavity 150. The body wall 112 of the casing 102 includes a conductive inner surface 202 that surrounds and partially defines the interior cavity 150. The inner surface 202 surrounds the central axis 190 and may define a radial boundary of the interior cavity 150. For instance, in the illustrated embodiment, the inner surface 202 extends entirely about the central axis 190 and defines a radial perimeter of the interior cavity 150. The user interface 104 and the base wall 122 may define top and bottom boundaries of the interior cavity 150. In some embodiments, such as smartwatches, the base wall 122 is configured to be positioned adjacent to the individual.

When the antenna element 120 is operably positioned within the interior cavity 150 and the first and second ground extensions 172, 174 are engaged with the inner surface 202, the first and second ground extensions 172, 174 are deflected away from the user interface 104. As shown, the antenna element 120 is oriented such that the antenna plane 198 (FIG. 4) is perpendicular to the central axis 190. The antenna plane 198 may extend essentially parallel to the display side 156 of the transparent substrate 154 and/or to the top side 105 of the wireless device 100. The operative slot 204 may coincide with the antenna plane 198. As such, the operative slot 204 may be characterized as extending essentially parallel to the display side 156 of the transparent substrate 154. In some embodiments, the operative slot 204 may be characterized as extending essentially parallel to the top side 105 of the wireless device 100.

The operative slot 204 is defined widthwise (or laterally) between the outer edge 178 and the inner surface 202 and lengthwise between the first and second ground extensions 172, 174. The operative slot 204 has a width 206 (shown in FIG. 7) measured between the outer edge 178 and the inner surface 202. In some embodiments, the width 206 is less than one (1) centimeter (cm). In more particular embodiments, the width 206 is less than five (5) millimeters (mm). In some embodiments, the slot length 194 (FIG. 4) may be, for example, less than five (5) cm or, more particularly, less than three (3) cm. In some embodiments, the operative slot 204 may extend along at least one-quarter (¼) of the perimeter as defined by the inner surface 202 about the central axis 190. In particular embodiments, the operative slot 204 may extend along at least one-third (⅓) of the perimeter. In more particular embodiments, the operative slot 204 may extend along at least one-half (½) of the perimeter or at least three-quarters (¾) of the perimeter. Optionally, the operative slot 204 may extend along at most one-quarter (¼) of the perimeter.

The various elements of the wireless device 100 are stacked relative to one another along the central axis 190. When the wireless device 100 is fully constructed, the printed circuit 124 is disposed within the interior cavity 150. The interior cavity 150 has a first region 214 between the printed circuit 124 and the user interface 104 and/or the antenna element 120, and a second region 216 that is defined between the printed circuit 124 and the base wall 122. The second side surface 166 of the antenna element 120 is exposed to the first region 214 of the interior cavity 150. The vibrator 146 is disposed within the second region 216. The operable components 140 (FIG. 2), 142 (FIG. 2), 144, 145, 148 (FIG. 2), and 149 (FIG. 2) are disposed within the first region 214.

The interior supports 126, 128 are also disposed within the interior cavity 150. The interior supports 126, 128 have support surfaces 127, 129, respectively (shown in FIG. 2) that are configured to engage or interface with corresponding portions of the cavity side 158 of the transparent substrate 154. More specifically, the transparent substrate 154 is held between the interior supports 126, 128 and the ledge section 132 of the casing 102. The interior supports 126, 128 may also be used to support other components, such as the printed circuit 124.

The ledge section 132 includes a casing edge 218 that defines the first opening 136 to the interior cavity 150. As shown, the user interface 104 covers the first opening 136. In the illustrated embodiment, the user interface 104 occupies and extends through the first opening 136. In other embodiments, however, the user interface 104 may not extend through or occupy the first opening. For example, the casing 102 may only include the vertical section 130 of the body wall 112 and be devoid of a ledge section. In such embodiments, the casing 102 may be a simple cylinder. The user interface 104 may rest upon an edge of the casing 102 such that the user interface 104 covers the first opening without extending into the interior cavity 150. In such embodiments, the antenna element 120 may be positioned at the first opening. The body wall 112 also includes a base edge 219 that is configured to interface or engage with the base wall 122. The base edge 219 may define the second opening 138.

The wireless device 100 has a device height 210 measured along the central axis 190. The device height 210 is measured between the display side 156 of the transparent substrate 154 and a base side 212 of the base wall 122. As described herein, the slot antenna 125 (FIG. 6) may allow the device height 210 to be reduced compared to other wireless devices. As one example, the wireless device 100 may have a device height of at most 2 cm.

FIG. 6 is a top-down cross-sectional view of the wireless device 100, and FIG. 7 illustrates a plan view of the casing 102 and the antenna element 120 forming the operative slot 204. In each of the FIGS. 6 and 7, the user interface 104 (FIG. 1) has been removed thereby revealing the antenna element 120 in the interior cavity 150. In FIG. 7, other components have been removed to more clearly show a spatial relationship between the casing 102 and the antenna element 120. As shown in FIGS. 6 and 7, the first and second ground extensions 172, 174 are engaged with the inner surface 202 of the body wall 112. The operative slot 204 extends lengthwise between the first and second ground extensions 172, 174 and widthwise between the inner surface 202 and the outer edge 178.

Turning to FIG. 6, the slot antenna 125 includes the operative slot 204 and a feed line 225. As shown, the body wall 112, which defines the interior cavity 150, also defines a portion of the exterior surface 110. The body wall 112 may provide structural integrity to the wireless device 100 while simultaneously working in conjunction with the antenna element 120 to form the slot antenna 125.

In other embodiments, however, the body wall 112 may provide structural integrity to the wireless device 100 while simultaneously forming the slot antenna 125 without extending entirely around the central axis 190. For example, the body wall 112 may be an arcuate section that extends along only the operative slot 204 and engages the first and second ground extensions 172, 174. In such embodiments, the body wall 112 may be overmolded with a dielectric material to form the casing. Alternatively, the body wall 112 may be coupled to other structural elements to form the casing. Nevertheless, the body wall 112 may define the operative slot 204 and, optionally, a portion of the exterior surface 110.

Also shown in FIG. 6, the antenna element 120 may have an adhesive layer 220 disposed along the first side surface 164. Alternatively or in addition to the first side surface 164, the cavity side 162 (FIG. 3) of the electronic display 152 (FIG. 3) may have an adhesive layer 220 disposed thereon. In the illustrated embodiment, the second ground extension 174 extends through a channel 222 of the interior support 126. The channel 222 permits the second ground extension 174 to engage the inner surface 202. In some embodiments, the operative slot 204 may have a dielectric material disposed therein. For example, a portion of the interior support 126 occupies a region between the outer edge 178 and the inner surface 202. Likewise, a portion of the interior support 128 occupies a region between the outer edge 178 and the inner surface 202. In such embodiments, the operative slot 204 and other parameters may be tuned to accommodate the dielectric material.

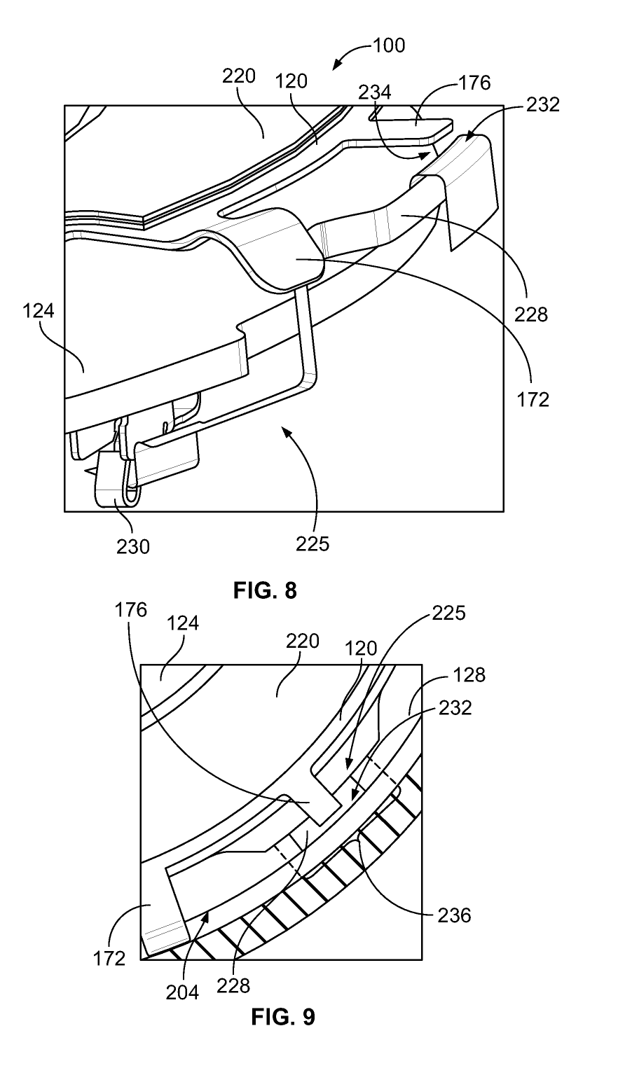

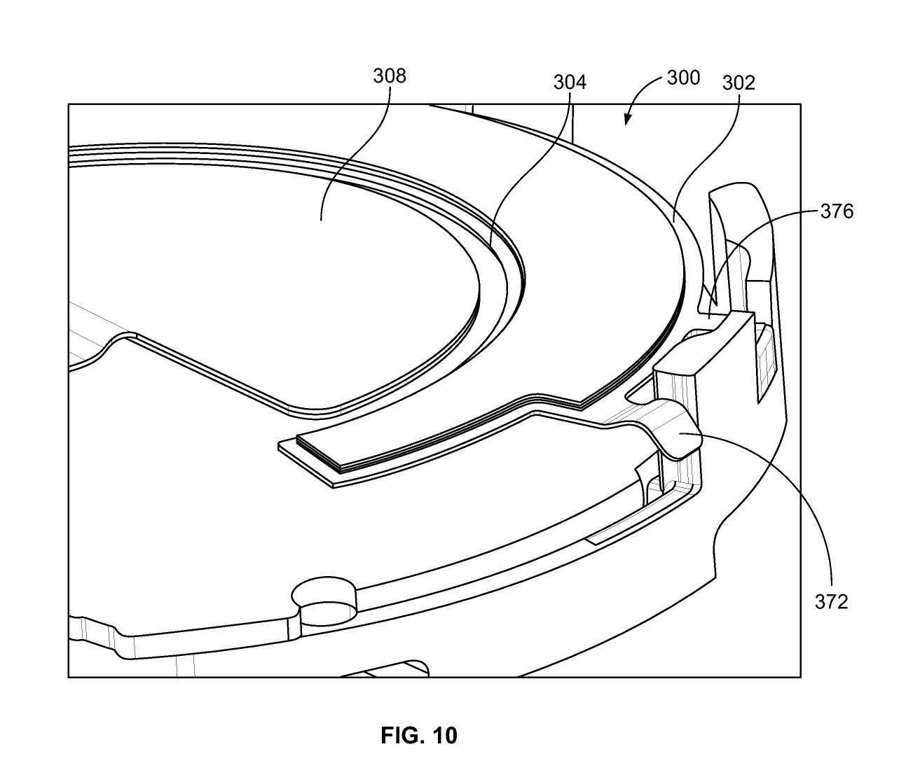

FIG. 8 is an enlarged view of only a portion of the wireless communication device 100. More specifically, FIG. 8 shows the printed circuit 124, the antenna element 120, the adhesive layer 220, and a feed line 225. FIG. 9 is an enlarged plan view that illustrates the antenna element 120, the adhesive layer 220, the interior support 128, and the feed line 225. The feed line 225 includes a conductive pathway 228 and an electrical connector 230 (FIG. 8) that electrically couples the conductive pathway 228 to the printed circuit 124. The printed circuit 124 may include conductive pathways (not shown), such as traces and vias, that communicatively couple the feed line 225 to the radio 140 (FIG. 2). In the illustrated embodiment, the conductive pathway 228 is a stamped-and-formed trace that may be supported by the interior support 128 (FIG. 9). The interior support 128 is shaped to include a recess 236 (FIG. 9) where the conductive pathway 228 is exposed. In the illustrated embodiment, the electrical connector 230 is a C-clip. It should be understood, however, that the feed line 225 shown in FIGS. 8 and 9 is just one example of a feed line and alternative feed lines may be used.

The radio 140 (FIG. 2) is configured to excite the operative slot 204 (FIG. 9). In the illustrated embodiment, the conductive pathway 228 has a probe surface 232 that is exposed along the recess 236 and faces the coupling extension 176. The probe surface 232 and the coupling extension 176 are separated by a gap 234 (FIG. 8). As such, the probe surface 232 and the coupling extension 176 are capacitively coupled. The radio 140 may selectively excite the operative slot 204 through the capacitive coupling between the coupling extension 176 and the probe surface 232.

FIG. 10 is a perspective view of a portion of a wireless device 300 according to another specific embodiment. The wireless device 300 may be nearly identical to the wireless device 100 (FIG. 1) and include an antenna element 302 that is identical to the antenna element 120 (FIG. 2). For reference, the antenna element 302 includes a grounding extension 372 and a coupling extension 376, which may be identical to the grounding extension 172 (FIG. 3) and the coupling extension 176 (FIG. 3), respectively. The antenna element 302 is configured to form a slot antenna with the casing (not shown) of the wireless device 300. As shown, the antenna element 302 has an inner edge 304 that defines a void 306. The wireless device 300 also includes an NFC antenna element 308. The NFC element 308 is an essentially two-dimensional structure. As shown in FIG. 10, the NFC element 308 is positioned within the void 306. In some embodiments, the NFC antenna element 308 may coincide within the antenna plane defined by the antenna element 302.

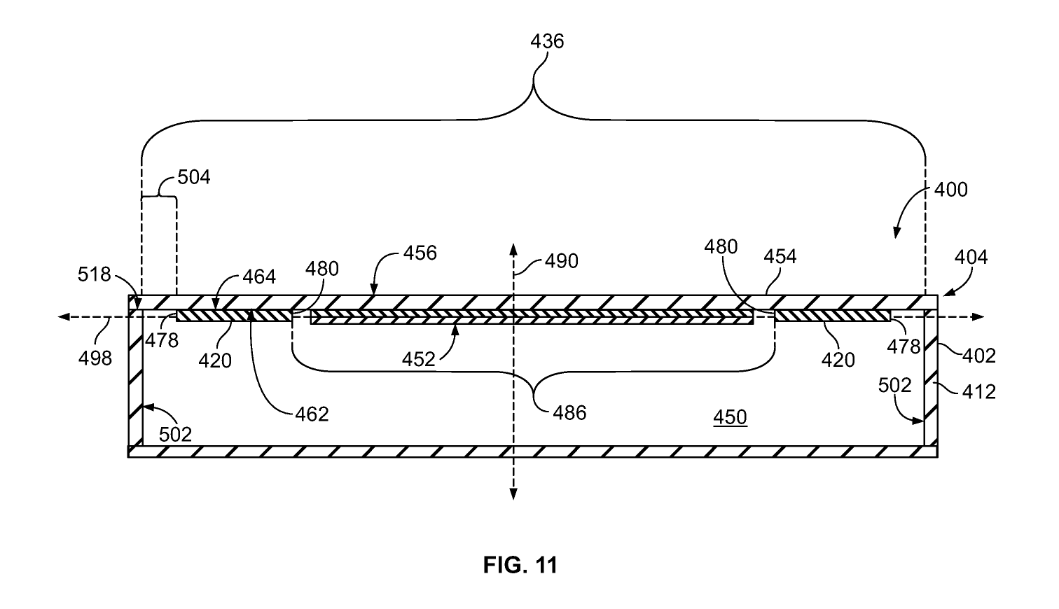

FIG. 11 is a side cross-sectional view of a wireless device 400. The wireless device 400 may include elements and features that are similar or identical to the elements and features of the wireless device 100 (FIG. 1). For example, the wireless device 400 includes a user interface 404 having an electronic display 452 that is configured to generate light and a transparent substrate 454 that is coupled to the electronic display 452. The transparent substrate 454 has a display side 456 of the wireless communication device 400 and is configured to permit the light to propagate through the transparent substrate 454. The wireless device 400 also includes a casing 402 having a body wall 412 that includes an inner surface 502 that surrounds an interior cavity 450 of the casing 402. The body wall 412 extends continuously around a central axis 490. The casing 402 has an edge 518 that defines an opening 436 to the interior cavity 450. The user interface 404 is positioned to cover the opening 436. For illustrative purposes, some interior components of the wireless device 400 are not shown in the interior cavity 450. It should be understood that the wireless device 400 may include similar or identical interior components, such as the operable components 140, 142, 144, 145, 148, 149 (FIG. 2) and the printed circuit 124 (FIG. 2).

The wireless device 400 also includes an antenna element 420 positioned at the opening 436 or within the interior cavity 450. The antenna element 420 may be similar or identical to the antenna element 120 (FIG. 2). For example, the antenna element 420 has an outer edge 478 that is shaped to extend generally along and spaced apart from the inner surface 502 such that the outer edge 478 and the inner surface 502 form an operative slot 504 therebetween. Although not shown, the antenna element 420 may include one or more ground extensions, such as the ground extensions 172, 174 (FIG. 3), that engage the inner surface 502. Also not shown, the wireless device 400 may also include a feed line that is communicatively coupled to the operative slot 504. The feed line may be similar or identical to the feed line 225 (FIG. 6) and may form a slot antenna with the operative slot 504.

As shown, the operative slot 504 coincides with an antenna plane 498 that is parallel to the display side 456 of the wireless device 400. The antenna element 420 extends around the central axis 490 such that an inner edge 480 of the antenna element 420 defines a void 486. In the illustrated embodiment, portions of the user interface 404 may be disposed within the void 486. For example, the electronic display 452 may be disposed within the void 486 defined by the inner edge 480 of the antenna element 420.

The antenna element 420 has a side surface 464 that faces the user interface 404. The side surface 464 of the antenna element 420 may be secured to a cavity side 462 of the user interface 404 such that the user interface 404 holds the antenna element 420 in an essentially fixed position during operation of the wireless device 400. In the illustrated embodiment, the cavity side 462 is a portion of the transparent substrate 454. For example, the transparent substrate 454 may radially clear the electronic display 452 to provide a radial area of the cavity side 462 for securing the antenna element 420 thereto. In such embodiments, the display side 456 and/or the cavity side 462 may include a non-transparent coating that extends along a portion of the transparent substrate 454 and/or around an edge of the transparent substrate 454. The non-transparent coating may cover or hide the antenna element 420 from the user.

Accordingly, antenna elements set forth herein may be secured to a transparent substrate (e.g., glass) or an electronic display of a user interface. It is also contemplated that antenna elements may be secured to a cover of the wireless device that does not include an interactive display. For example, the user interface 404 in FIG. 11 may, instead, be a device cover 404 that is coupled to the casing 402. The device cover 404 may be sheet metal or a dielectric material. The side surface 464 of the antenna element 420 may face the device cover 404. The side surface 464 of the antenna element 420 may be secured to a cavity side 462 of the device cover 404 such that the device cover 404 holds the antenna element 420 in an essentially fixed position during operation of the wearable electronic device.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The patentable scope should, therefore, be determined with reference to the appended claims, along with the full scope of equivalents to which such claims are entitled.

As used in the description, the phrase “in an exemplary embodiment” and the like means that the described embodiment is just one example. The phrase is not intended to limit the inventive subject matter to that embodiment. Other embodiments of the inventive subject matter may not include the recited feature or structure. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112(f), unless and until such claim limitations expressly use the phrase “means for” followed by a statement of function void of further structure.

What is claimed is:

1. A wireless communication device comprising:
a user interface including an electronic display that is configured to generate light and a transparent substrate coupled to the electronic display, the transparent substrate having a display side of the wireless communication device and being configured to permit the light to propagate through the transparent substrate;
a casing having a body wall that includes an inner surface that surrounds an interior cavity of the casing, the casing having an edge that defines an opening to the interior cavity, wherein the user interface is positioned to cover the opening;
an antenna element positioned at the opening or within the interior cavity, the antenna element having an outer edge that is shaped to extend generally along and spaced apart from the inner surface such that the outer edge and the inner surface form an operative slot therebetween; and
a feed line communicatively coupled to the operative slot, the feed line and the operative slot forming a slot antenna that is configured to at least one of transmit or receive radio-frequency (RF) waves.

2. The wireless communication device of claim 1, further comprising at least one strap that is coupled to the casing and configured to wrap about a limb of an individual, the wireless communication device being a wearable electronic device.

3. The wireless communication device of claim 1, wherein the operative slot coincides with an antenna plane that is parallel to the display side of the wireless communication device.

4. The wireless communication device of claim 1, wherein the antenna element has a side surface that faces the user interface, the side surface of the antenna element being secured to a cavity side of the user interface such that the user interface holds the antenna element in an essentially fixed position during operation of the wireless communication device.

5. The wireless communication device of claim 1, wherein the electronic display, the transparent substrate, and the antenna element have respective two-dimensional structures that are stacked with respect to one another.

6. The wireless communication device of claim 1, wherein the antenna element includes a main section and a ground extension that projects from the main section and engages the inner surface, the ground extension defining an end of the operative slot.

7. The wireless communication device of claim 6, wherein the ground extension is a first ground extension and the antenna element includes a second ground extension that projects from the main section and engages the inner surface, the operative slot being defined between the first and second ground extensions.

8. The wireless communication device of claim 6, wherein the ground extension includes a ground finger, the ground finger being deflected away from the user interface when engaged to the inner surface.

9. The wireless communication device of claim 1, wherein the inner surface extends entirely about a central axis that is perpendicular to the display side and defines a perimeter of the interior cavity, the operative slot extending along at least one-third of the perimeter.

10. The wireless communication device of claim 1, wherein the antenna element has an inner edge that defines a void, the wireless communication device including at least one other object disposed in the void.

11. The wireless communication device of claim 1, wherein the opening of the casing is a first opening, the casing including a base edge that defines a second opening, the wireless communication device further comprising a base wall that covers the second opening and is coupled to the casing.

12. The wireless communication device of claim 11, further comprising a processor disposed in the interior cavity and operably coupled to the electronic display, the processor configured to control operation of the electronic display to display graphical objects to a user of the wireless communication device, the processor being secured to the base wall.

13. A wearable electronic device comprising:
a casing having a body wall that includes an inner surface surrounding an interior cavity of the casing;
at least one strap coupled to the casing and configured to wrap about a limb of an individual;
an antenna element positioned within the interior cavity of the casing, the antenna element having an outer edge that is shaped to extend generally along and spaced apart from the inner surface such that the outer edge and the inner surface form an operative slot therebetween; and
a feed line communicatively coupled to the operative slot, the feed line and the operative slot forming a slot antenna that is configured to at least one of transmit or receive radio-frequency (RF) waves.

14. The wearable electronic device of claim 13, wherein the casing includes a base wall that is configured to be positioned adjacent to the individual, wherein the operative slot coincides with an antenna plane that is parallel to the base wall.

15. The wearable electronic device of claim 13, wherein the antenna element includes a main section and a ground extension that projects from the main section and engages the inner surface, the ground extension defining an end of the operative slot.

16. The wearable electronic device of claim 15, wherein the ground extension is a first ground extension and the antenna element includes a second ground extension that projects from the main section and engages the inner surface, the operative slot being defined between the first and second ground extensions.

17. The wearable electronic device of claim 15, wherein the ground extension includes a ground finger, the ground finger being deflected toward a bottom of the wearable electronic device that is configured to be adjacent to the individual.

18. The wearable electronic device of claim 13, wherein the inner surface extends entirely about a central axis and defines a perimeter of the interior cavity, the operative slot extending along at least one-third of the perimeter.

19. The wearable electronic device of claim 13, wherein the antenna element has an inner edge that defines a void, the wearable electronic device including at least one other object disposed in the void.

20. The wearable electronic device of claim 13, further comprising a device cover coupled to the casing, the antenna element having a side surface that faces the device cover, the side surface of the antenna element being secured to a cavity side of the device cover such that the device cover holds the antenna element in an essentially fixed position during operation of the wearable electronic device.
